(19) United States
(12) Patent Application Publication
(10) Pub. No.: US 2022/0024787 A1
(43) Pub. Date: Jan. 27, 2022

(54) METHOD AND APPARATUS FOR COPPER-CATALYZED ELECTROCHEMICAL WATER TREATMENT

(71) Applicant: CAPE BRETON UNIVERSITY, Sydney (CA)

(72) Inventors: Guoqiang LI, Glace Bay (CA); Albert Collins NGANOU ASSONKENG, Sydney (CA); Andrew James CARRIER, Sydney (CA); Xu ZHANG, Sydney (CA)

(21) Appl. No.: 17/250,918

(22) PCT Filed: Oct. 10, 2019
(86) PCT No.: PCT/CA2019/051443

§ 371 Date: Mar. 26, 2021

Related U.S. Application Data
(60) Provisional application No. 62/744,146, filed on Oct. 11, 2018.

(51) Int. Cl. C02F 1/461; C02F 1/00; C02F 1/467

(52) U.S. Cl. CPC C02F 1/46104; C02F 1/008; C02F 1/4672; C02F 2101/20; C02F 2201/46145; C02F 2201/46135; C02F 1/4678

(57) ABSTRACT

A method and apparatus for copper-catalyzed electrochemical water treatment are provided. The method comprises the steps of supplying an aqueous solution and electrochemically treating the aqueous solution in an electrochemical cell comprising an anode, a cathode, and the aqueous solution as an electrolyte, by applying an electric potential to said anode and said cathode, thereby producing purified water. The apparatus comprises an electrochemical cell comprising an anode, a cathode, and an electrolyte, the electrolyte contacting the anode and the cathode; an inlet allowing the electrolyte in the electrochemical cell; and an outlet allowing purified water out of the electrochemical cell. In both cases, the electrolyte/aqueous solution comprises water to be treated, chloride ions in a concentration [Cl⁻] at least about 10 mM, and copper(II) and/or copper(I) ions in a total copper ions concentration, [CU²⁺] +[Cu⁺], of at least about 20 μM.

### CROSS REFERENCE TO RELATED APPLICATIONS

This application claims benefit, under 35 U.S.C. § 119(e), of U.S. provisional application Ser. No. 62/744,146, filed on Oct. 11, 2018. All documents above are incorporated herein in their entirety by reference.

### FIELD OF THE INVENTION

The present invention relates to a method and an apparatus for treating water. More specifically, the method and apparatus of the invention allow the copper-catalyzed electrochemical removal of both organic and heavy metal contaminants.

### BACKGROUND OF THE INVENTION

Water treatment and purification is important to human and environmental health. There are many extant methods for performing purification, most notably using activated sludge in a modern sanitary sewage system. However, not all water treatment methods are effective for all contaminants and depending on the desired outcome multiple purification methods may be used. In addition to sanitary sewer systems, water can be purified by so-called advanced oxidation processes, which typically involve the generation of free radical species through combinations of metal ions, most often iron ions, and an oxidant, e.g., ozone or hydrogen peroxide.

In one such oxidation process, iron ions, Fe³⁺ and Fe²⁺, are widely used in Fenton chemistry (reaction with hydrogen peroxide to generate free radicals, i.e., hydroxyl radical), including electrochemical versions of the reaction that generate hydrogen peroxide in situ. The significant challenge in this chemistry is the generation of hydrogen peroxide via reduction of dissolved oxygen, which makes this technology slow and with a low current efficiency. It also appears to only generate hydroxyl radical as a powerful short-lived oxidant, so it only oxidizes materials very close to the electrode surface. If operated in flow mode (in contrast to batch mode), the flow rate would need to be exceptionally slow to achieve meaningful degradation. Thus, this technology is generally operated in a batch mode.

Furthermore, these Fenton-chemistry based methods (typically using a solution of hydrogen peroxide with ferrous iron, typically FeSO₄, as a catalyst used to oxidize contaminants or waste waters) are often pH sensitive and typically require the addition of oxidants in proportion to the amount of water contaminants. Electrochemical oxidation of dissolved organic molecules in water proceeds by successive removal of electrons from the pollutants by an inert electrode followed by reaction with water to slowly oxidize and break apart molecules until they are mineralized into carbon dioxide and water (or other dissolved species, e.g., nitrate from nitrogen containing waste). However, as noted above, currently available technologies are hampered by very slow reaction rates that prevents this technology from being commercially viable. These reactions can also be promoted by the application of ultraviolet light or electrical energy. Nevertheless, these free radial based oxidations, whose goal is complete mineralization of organic contaminants to carbon dioxide, water, and other inorganic species do not remove heavy metal contamination. Such heavy metal contamination is also not removed by biological treatment. Rather, it typically requires the application of adsorbents or precipitants, which can be costly and generate secondary contaminated waste.

### SUMMARY OF THE INVENTION

In accordance with the present invention, there is provided:
1. A method for electrochemical water treatment, the comprising the steps of:
   a) supplying an aqueous solution comprising:
      water to be treated,
      chloride ions, and
      copper(II) and/or copper(I) ions,
   wherein the total copper ions concentration, [Cu²⁺]+[Cu⁺], in the aqueous solution is at least about 20 μM and the chloride ion concentration, [Cl⁻], in the aqueous solution is at least about 10 mM; and
   b) electrochemically treating the aqueous solution in an electrochemical cell comprising an anode, a cathode, and the aqueous solution as an electrolyte, by applying an electric potential to said anode and said cathode, thereby producing purified water.
2. The method of item 1, wherein one or more organic contaminants are removed from the aqueous solution during step b).
3. The method of item 2, wherein the organic contaminants are oxidized and mineralized during step b).
4. The method of any one of items 1 to 3, wherein one or more metallic contaminants are removed from the aqueous solution during step b).
5. The method of item 4, wherein the metallic contaminants are reductively adsorbed during step b).
6. The method of any one of items 1 to 5, wherein the total copper ions concentration in the aqueous solution is at least about 50 μM, preferably at least about 100 μM, and yet more preferably at least about 150 μM.
7. The method of any one of items 1 to 5, wherein the aqueous solution supplied in step a) is produced by adding a water-soluble Cu(II) or Cu(I) salt, preferably a water-soluble Cu(II) salt, to water to be treated.
8. The method of item 7, wherein the water-soluble Cu(II) or Cu(I) salt is a Cu(II) or Cu(I) sulfate, chloride, chlorate, perchlorate, bromide, formate, acetate, iodate, selenate, or nitrate salt; preferably Cu(II) chloride, Cu(II) sulfate, or C(II) nitrate; and more preferably Cu(II) chloride.
9. The method of any one of items 1 to 8, wherein the total chloride ion concentration in the water solution is at least about 100 mM, preferably at least about 500 mM, and yet more preferably at least about 1000 mM.
10. The method of any one of items 1 to 9, wherein the water solution supplied in step a) is produced by adding a water-soluble chloride salt to water to be treated.
11. The method of item 10, wherein the water-soluble chloride salt is an alkali metal chloride salt, an alkaline earth metal chloride salt, ammonium chloride, an alkylammonium chloride salt, or a phosphonium chloride salt; preferably an alkali metal chloride salt; and more preferably sodium chloride.
12. The method of any one of items 1 to 11, wherein the electric potential applied to the anode and the cathode ranges from about −1.5 to about +5 V; preferably from about −1.5 to about 3 V.
13. The method of any one of items 1 to 11, wherein a different potential is applied to the anode and to the cathode.
14. The method of item 13, wherein a potential between about +1.2 V and about +3.0 V, preferably a potential of about +1.5 V, relative to the standard hydrogen electrode, is applied to the anode.
15. The method of item 13 or 14, wherein a potential between about 0 V and about −1.5 V, preferably a potential of about -1.5 V, relative to the standard hydrogen electrode, is applied to the cathode.
16. The method of any one of items 1 to 15, wherein the pH of the aqueous solution ranges from about 1 to about 12, preferably from about 6 to about 7.
17. The method of any one of items 1 to 16, wherein the residence time of the aqueous solution in the electrochemical cell ranges from about 1 minute to about 1 hour, preferably from about 1 minute to about 30 minutes, more preferably from about 1 minute to about 15 minutes, yet most preferably from about 1 minute to about 5 minutes.
18. The method of item 17, wherein the residence time is about 4 minutes.
19. The method of any one of items 1 to 18, wherein the method is free of a step of adding to the aqueous solution any one or more (preferably all) of the following:
peroxydisulfate ions (S₂O₈²⁻);
peroxymonosulfate ions (SO₅²⁻);
ozone;
hypochlorous acid (HOCl);
hypochlorite ions (ClO⁻);
chlorite ions (ClO₂₋);
chlorate ions (ClO₃₋);
perchlorate ions (ClO₄₋);
chlorine;
bromine;
iodine;
H₂O₂;
other chemical oxidants;
iron salts, including water-soluble iron salts, e.g. water-soluble ferrous salts, e.g. FeSO₄; or
iron minerals (e.g. pyrite, magnetite or goethite).
20. The method of any one of items 1 to 19, wherein the aqueous solution has a concentration of any one or more (preferably all) of the following below a concentration sufficient to achieve water treatment:
peroxydisulfate ions (S₂O₈²⁻);
peroxymonosulfate ions (SO₅²⁻);
ozone;
hypochlorous acid (HOCl);
hypochlorite ions (ClO⁻);
chlorite ions (ClO₂−);
chlorate ions (ClO₃−);
perchlorate ions (ClO₄−);
chlorine;
bromine;
iodine;
H₂O₂;
other chemical oxidants;
iron salts, including water-soluble iron salts, e.g. water-soluble ferrous salts, e.g. FeSO₄; or
iron minerals (e.g. pyrite, magnetite or goethite).
21. The method of any one of items 1 to 20, wherein the aqueous solution is free of any one or more (preferably all) of the following:
peroxydisulfate ions (S₂O₈²⁻);
peroxymonosulfate ions (SO₅²⁻);
ozone;
hypochlorous acid (HOCl);
hypochlorite ions (ClO⁻);
chlorite ions (ClO₂−);
chlorate ions (ClO₃−);
perchlorate ions (ClO₄−);
chlorine;
bromine;
iodine;
H₂O₂;
other chemical oxidants;
iron salts, including water-soluble iron salts, e.g. water-soluble ferrous salts, e.g. FeSO₄; or
iron minerals (e.g. pyrite, magnetite or goethite).
22. An apparatus for electrochemical water treatment, the apparatus comprising
   an electrochemical cell comprising an anode, a cathode, and an electrolyte, the electrolyte contacting the anode and the cathode;
   an inlet allowing the electrolyte in the electrochemical cell; and
   an outlet allowing purified water out of the electrochemical cell,
      wherein the electrolyte is an aqueous solution comprising:
   water to be treated,
   chloride ions (Cl⁻), and
   copper(II) and/or copper(I) ions,
      wherein the total copper ions concentration, [Cu²⁺]+[Cu⁺], in the aqueous solution is at least about 20 μM and the chloride ion concentration, [Cl⁻], in the aqueous solution is at least about 10 mM.
23. The apparatus of item 22, for use in the method of any one of items 1 to 21.
24. The apparatus of item 22 or 23, wherein the electrochemical cell is a flow-through electrochemical cell elongated in shape, and wherein the inlet is at one end of the electrochemical cell and the outlet at the other end of the electrochemical cell.
25. The apparatus of any one of items 22 to 24, wherein the anode and the cathode are made of a porous conductive material.
26. The apparatus of any one of items 22 to 25, wherein the anode and the cathode made of graphite felt or carbon felt, preferably graphite felt.
27. The apparatus of any one of items 22 to 26, wherein the anode and the cathode each permeably occlude one end of the electrochemical cell towards the inlet and the outlet.
28. The apparatus of any one of items 22 to 27, further comprising a reference electrode.
29. The apparatus of any one of items 22 to 28, further comprising a pump for mobilizing the electrolyte through the electrochemical cell.
30. The apparatus of any one of items 22 to 29, further comprising a voltage source, preferably a potentiostat.
31. The apparatus of any one of items 22 to 30, further comprising one or more sensors for detecting one or more characteristics of the electrolyte entering the electrochemical cell and/or one or more characteristics of the purified water exiting the electrochemical cell.
32. The apparatus of any one of items 29 to 30, further comprising a microcomputer.
33. The apparatus of item 32, wherein the microcomputer monitors the one or more characteristics detected by the one or more sensors and/or provides feedback as needed to the pump to adjust the electrolyte flow rate and/or to the voltage source to adjust the electrical potential applied to the electrodes to maximize purified water throughput at a given output water quality.
34. The apparatus of any one of items 22 to 33, comprising several electrochemical cells in parallel.
35. The apparatus of any one of items 22 to 34, wherein the electrochemical cell is for operation in batch mode.
36. The apparatus of any one of items 22 to 34, wherein the electrochemical cell is for operation in flow mode.
37. The apparatus of any one of items 22 to 36, wherein the aqueous solution has a concentration of any one or more (preferably all) of the following below a concentration sufficient to achieve water treatment:
   peroxydisulfate ions (S₂O₈²⁻);
   peroxymonosulfate ions (SO₅²⁻);
ozone;
hypochlorous acid (HOCl);
hypochlorite ions (ClO⁻);
chlorite ions (ClO₂₋);
chlorate ions (ClO₃₋);
perchlorate ions (ClO₄₋);
chlorine;
bromine;
iodine;
H₂O₂;
other chemical oxidants;
iron salts, including water-soluble iron salts, e.g. water-soluble ferrous salts, e.g. FeSO₄; or
iron minerals (e.g. pyrite, magnetite or goethite).
38. The apparatus of any one of items 22 to 37, wherein the aqueous solution is free of any one or more (preferably all) of the following:
peroxydisulfate ions (S₂O₈²⁻);
peroxymonosulfate ions (SO₅²⁻);
ozone;
hypochlorous acid (HOCl);
hypochlorite ions (ClO⁻);
chlorite ions (ClO₂₋);
chlorate ions (ClO₃₋);
perchlorate ions (ClO₄₋);
chlorine;
bromine;
iodine;
H₂O₂;
other chemical oxidants;
iron salts, including water-soluble iron salts, e.g. water-soluble ferrous salts, e.g. FeSO₄; or
iron minerals (e.g. pyrite, magnetite or goethite).

### BRIEF DESCRIPTION OF THE DRAWINGS

In the appended drawings:

FIG. 1 is a cross-sectional schematic diagram of an electrochemical cell for electrochemical water treatment according to an embodiment of the invention.

FIG. 2 shows the mass spectra of the starting solution used in Example 1 (top) and of the resulting treated water (bottom).

FIG. 3 shows the effect of Cu²⁺ concentration on Total Organic Carbon (TOC) removal efficiency.

FIG. 4 shows the effect of NaCl concentration on TOC removal efficiency.

FIG. 5 shows the effect of voltage on TOC removal efficiency.

FIG. 6 shows the effect of pH on TOC removal efficiency.

FIG. 7 shows the effect of residence time on TOC removal efficiency as measured in Example 2.

FIG. 8 shows the effect of residence time on TOC removal as measured from the “geotube” sample in Example 3.

FIG. 9 shows the removal of volatile organic compounds from the “geotube” sample as characterized by gas chromatography mass spectrometry (GCMS).

FIG. 10 shows the removal of volatile organic compounds from the “PW-1” sample in Example 3 as characterized by GCMS.

FIG. 11 shows the removal of volatile organic compounds from the “PW-2” sample in Example 3 as characterized by GCMS.

### DETAILED DESCRIPTION OF THE INVENTION

### Method for Electrochemical Water Treatment

Turning now to the invention in more details, there is provided a method for electrochemical water treatment.

The method of the invention comprises the steps of:
a) supplying an aqueous solution comprising water to be treated, chloride ions (CI⁻) and copper(II) and/or copper(I) ions (Cu²⁺ and/or Cu⁺), wherein the total copper ions (Cu²⁺+Cu⁺) concentration in the aqueous solution is at least about 20 μM and the chloride ion (CI⁻) concentration in the aqueous solution is at least about 10 mM; and
b) electrochemically treating the aqueous solution in an electrochemical cell comprising an anode, a cathode, and the aqueous solution as an electrolyte, by applying an electric potential to said anode and cathode, thereby producing purified water.

Indeed, it has been surprisingly found that copper ions (Cu²⁺ and Cu⁺) act as an electrocatalyst to generate reactive oxygen species (ROS) on the anode (which ROS then participate in the oxidation of organic contaminants) as well as contributing to direct anodic oxidation and mineralization of organic contaminants, while also reducing dissolved heavy metal ions onto the cathode surface. Indeed, the conductive material making the cathode balances charge accumulation and reductively adsorbs heavy metal ions. Of note, “mineralization” is a well-known term in the art used to indicate that the organic compounds are completely converted to inorganic products, e.g. carbon dioxide and water, but also nitrate and phosphate for N- and P-containing compounds, respectively.

Thus, in the method of the invention, both organic and inorganic (metallic) contaminants are removed, via electrochemical oxidation and reductive adsorption, respectively, to produced purified water.

In embodiments, at least about 50 wt %, preferably at least about 75 wt %, more preferably at least about 75%, yet more preferably at least about 85 wt %, even more preferably at least about 95 wt %, and most preferably at least about 99 wt % of a given organic contaminant is removed from the water to be treated by the method of the invention.

In embodiments, one or more, preferably more than one, preferably all of the organic contaminants in the water to be treated are removed by the method of the invention.

In embodiments, at least about 50 wt %, preferably at least about 75 wt %, more preferably at least about 75%, yet more preferably at least about 85 wt %, even more preferably at least about 95 wt %, and most preferably at least about 99 wt % of a given metallic contaminant is removed from the water to be treated by the method of the invention.

In embodiments, one or more, preferably more than one of the metallic contaminants in the water to be treated are removed by the method of the invention.

As shown in Example 3 below, metallic contaminants removed or at least partially removed by the method of the invention include any one or more of, as well as any combination of: Al, Si, Ti, Cr, Mn, Fe, Co, Ni, Zn, As, Sr, Mo, Ag, Cd, and Pb.

In the method of the invention, the chloride ions, serves two main functions. In addition to serving as electrolyte, allowing the aqueous solution to be conductive and amenable to the electrochemical treatment, chloride ions act as ligands on the copper electrocatalyst, facilitating catalyst turnover by stabilizing the copper ions and accelerating the copper reduction process in the catalytic cycle. Thus, there is a synergy to the use of chloride ions with copper ions compared to the use of theses ions separately.

The method of the invention has greatly reduced residence times compared to the long residence times that characterize Fenton chemistry-based treatments. Indeed, the residence times are so reduced that they are amenable to flow systems, which is not the case of Fenton chemistry-based treatments. This is thus ideal for water treatment at remediation sites and industrial wastewater streams.

Further, in the method of the invention, it has been observed that powerful, long-lived oxidants are generated. These continue to purify water until excess oxidants are quenched on a counter-electrode. It has been observed that some ROS are indeed sufficiently long-lived and powerful enough to decompose, e.g., polypropylene even after the potential is removed from the electrodes. It is believed that short-lived oxidants, e.g., hydroxyl radical and singlet oxygen, oxidize contaminants near the electrode surface, whereas such long-lived oxidants, e.g., ozone and chlorine oxyanions (whose generation is possibly helped by the presence of chloride ions), continue to oxidize the water as it passes through the electrochemical reactor.

As noted above, only copper ions (Cu²⁺+Cu⁺) and chloride ions (CI⁻) are necessary to the method of the invention. Thus, in embodiments, the method is free of (i.e. does not comprise) a step of adding any one or more (preferably all) of the following to the aqueous solution:
peroxydisulfate ions (S₂₈²⁻);
peroxymonosulfate ions (SO₅²⁻);
ozone;
hypochlorous acid (HOCI);
hypochlorite ions (ClO⁻);
chlorite ions (ClO₂⁻);
chlorate ions (ClO₃);
perchlorate ions (ClO₄⁻);
chlorine (as opposed to the chloride ions used in the present invention);
bromine;
iodine;
H₂O₂;
other chemical oxidants;
iron salts, including water-soluble iron salts, e.g. water-soluble ferrous salts, e.g. FeSO₄; and
iron minerals (e.g. pyrite, magnetite or goethite).

In embodiments, the aqueous solution is free of any one or more (preferably all) of the above, and/or does not comprise any one or more (preferably all) of the above in a concentration that is sufficient to achieve water treatment, for example removal of the organic or metallic contaminants in a significant way (e.g. removing more than 5% of the organic or metallic contaminants).

Thus, as noted above, the total copper ions (Cu²⁺+Cu⁺) concentration in the aqueous solution is at least about 20 μM. In preferred embodiments, the total copper ions concentration in the aqueous solution is at least about 50 μM, preferably is at least about 100 μM, and yet more preferably is at least about 150 μM. There is no particular upper limit to the total copper ions concentration apart from that arising from the intrinsic water solubility of the water-soluble Cu(II) or Cu(I) salt used to introduce the copper ions in the aqueous solution. Of course, using excessive amounts of such salt would possibly needlessly and undesirably increase the operating cost.

In embodiments of the method of the invention, the aqueous solution that is supplied in step a) is produced by adding a water-soluble Cu(II) or Cu(I) salt, preferably a water-soluble Cu(II) salt, to water to be treated. Non-limiting examples of water-soluble Cu(II) or Cu(I) salts include Cu(II) and Cu(I) sulfate, chloride, chlorate, perchlorate, bromide, formate, acetate, iodate, selenate, and nitrate salts. Preferred water-soluble Cu(II) or Cu(I) salts include Cu(II) chloride, Cu(II) sulfate, and C(II) nitrate, and more preferably Cu(II) chloride.

Further, as also noted above, the chloride ion (CI⁻) concentration in the aqueous solution is at least about 10 mM. In preferred embodiments, the total chloride ion (CI⁻) concentration in the aqueous solution is at least about 100 mM, preferably at least about 500 mM, and yet more preferably at least about 1000 mM. There is no particular upper limit to the chloride ions concentration apart from that arising from the intrinsic water solubility of the water-soluble chloride salt used to introduce the chloride ions in the aqueous solution. Of course, using excessive amounts of such salt would possibly needlessly and undesirably increase the operating cost and/or cause the undesirable precipitation of the other material in the aqueous solution.

In embodiments of the method of the invention, the aqueous solution that is supplied in step a) is produced by adding a water-soluble chloride salt to water to be treated. Non-limiting examples of water-soluble chloride salts include alkali metal chloride salts, alkaline earth metal chloride salts, ammonium chloride, alkylammonium chloride salts, and phosphonium chloride salts. Preferred water-soluble chloride salts include alkali metal chloride salts, and more preferably sodium chloride.

The aqueous solution may be prepared by any known method. For example, the copper and chloride salts may be mixed water to be treated for example using any suitable mixing device. Alternatively, they can be added to the water to be treated under flow conditions, which would ensure proper mixing as well.

The water to be treated can be any water that is contaminated with organic and/or metallic contaminants, and from which solid contaminants, if any, have been removed. For example, the water to be treated may be seawater, surface water (from rivers, lakes, and other bodies of water), dam water, ground water, swimming pool water, agricultural runoff, industrial and domestic wastewaters [including so-called “grey water” (streams without fecal contamination), “black water (streams with fecal contamination), “clearwater” (solid-free wastewater)], from which solid contaminants have been removed as needed. The water to be treated may also be water that has been pre-treated using other known water treatment methods.

In embodiments, the electric potential applied to the anode and cathode ranges from about −1.5 to about +5 V. Preferably, the electric potential ranges from about −1.5 to about +3 V. It should be noted that these electric potentials are advantageously relatively low. So much so that they could be achieved e.g. using solar cells when the technology is used off-grid.

In alternative embodiments, a different potential can be applied to the anode and cathode. For example, a potential between about +1.2 V and about +3.0 V, preferably about +1.5 V, relative to the standard hydrogen electrode, can be applied to the anode (to perform the oxidation of the organic contaminants). Similarly, a potential between about 0 V and about −1.5 V, preferably about −1.5 V, relative to the standard hydrogen electrode, can be applied to the cathode (to perfume the reductive adsorption of the metallic contaminants).

In embodiments, the pH of the aqueous solution ranges from about 1 to about 12. Indeed, as shown in the Examples below, the method of the invention is quite robust and is workable over a broad range of pH. In other words, in embodiments, the method of the invention is free of steps comprising adjusting the pH of the aqueous solution. In preferred embodiments, the pH of the aqueous solution ranges from about 6 to about 7.

As shown in the Examples below, the residence time of the aqueous solution in the electrochemical cell to achieve a given level of removal of organic or metallic contaminants will depend on the several factors including the applied electric potential, total copper ions (Cu²⁺+Cu⁺) concentration, chloride ion (CI⁻) concentration, pH, levels of organic/inorganic contaminants, etc. Generally, the residence time may vary from about 1 minute to about 1 hour, preferably from about 1 minute to about 30 minutes, more preferably from about 1 minute to about 15 minutes, yet most preferably from about 1 minute to about 5 minutes. In preferred embodiments, the residence time is about 4 minutes.

The method of the invention can be carried out at any temperature where water is liquid. A temperature about room temperature is preferred to lower costs. Nevertheless, a slightly elevated temperature could be used to increase efficiency.

Care should be taken to avoid an excess of sulfide and phosphate ions, which could poison the electrocatalyst.

Given the above low requirements of the method of the invention, notably in terms of applied potential, residence time, chemical compounds, etc., the method of the invention can be carried out at a relatively low cost. In particular, the method of the invention avoids reducing innocuous ions, such as sodium, potassium, and calcium, which thus further help conserving electrical energy.

In embodiments, the method of the invention is carried out in an apparatus as described in the next section.

### Apparatus for Electrochemical Water Treatment

In another aspect of the invention, there is provided an apparatus for electrochemical water treatment.

The apparatus comprises:
an electrochemical cell comprising an anode, a cathode, and an electrolyte, the electrolyte contacting the anode and the cathode;
an inlet allowing the electrolyte in the electrochemical cell; and
an outlet allowing purified water out of the electrochemical cell,
   wherein the electrolyte is an aqueous solution comprising water to be treated, chloride ions (CI⁻) and copper ions (Cu²⁺ and/or Cu⁺), wherein the total copper ions (Cu²⁺+Cu⁺) concentration in the aqueous solution is at least about 20 μM and the chloride ion (CI⁻) concentration in the aqueous solution is at least about 10 mM.

In embodiments, the apparatus of the invention is for carrying out the method described in the previous section.

In embodiments, the electrochemical cell is a flow-through electrochemical cell elongated in shape with the inlet is at one end of the electrochemical cell and the outlet at the other end of the electrochemical cell. This setup allows operating the electrochemical cell in flow mode, which is preferred. However, it is also possible to operate in batch mode.

Indeed, the electrochemical cell can be operated either in batch or flow mode, depending on the nature and concentration of contaminant species and the engineering requirements of the water system to be treated. Generally, it is preferred to operate in flow mode wherein the electrolyte is mobilized through the electrochemical cell, for example using a pump or through gravity. When a pump is used, the electrolyte flow rate can be adjusted such that residence time (and thus output water quality) is optimized.

The anode and cathode may be any electrode amenable to the system. They can be composed of a variety of materials so long as they are stable under the reaction conditions. In preferred embodiments, the anode and the cathode are each made of a porous conductive material. This is preferred to maximize exposure of the electrolyte to the electrode surface. However, solid electrodes can still be used, but with lower efficiency. Graphite felt electrodes and carbon felt electrodes are preferred (graphite felt electrodes being slightly more preferred) because they are porous and relatively inexpensive. Other porous conductive materials could be used, e.g. platinum or gold mesh, as well. It is an advantage of the invention that there is no need to use “exotic materials” such as boron-doped diamond electrodes. While such electrodes can be used, in preferred embodiments, the electrodes are not boron-doped diamond electrodes.

In preferred embodiments, the anode and the cathode each permeably occlude one end of the electrochemical cell towards the inlet and the outlet. In other words, the electrolyte flowing in the cell through the inlet must go through one of the porous electrodes (either the anode or cathode), then flow along the length of the cell, flow through the other porous electrode and then exit the cell through the outlet.

A reference (or ground) electrode may or may not be used. In preferred embodiments, a reference electrode is used.

In embodiments, the apparatus further comprises a voltage source. As noted in the previous section, an electric potential is supplied across the anode and cathode, for example using a potentiostat or another system for controlling current applied. This can be performed using either direct or alternating current or a combination thereof. If the electrochemical cell is operated under flow conditions (rather than batch conditions) both the flow direction of the water to be treated and the polarity of the electrochemical cell can be reversed at any time or periodically. When such a potentiostat or other control system is used, the potential applied to the electrodes can be adjusted such that output water quality is optimized.

In embodiments, the apparatus further comprises one or more sensors for detecting various characteristics of the electrolyte entering the electrochemical cell and/or of the purified water exiting the electrochemical cell. This can be achieved based on various methods comprising such as refractive index, colorimetry, turbidity, total organic carbon, biological oxygen demand, chemical oxygen demand, ion selective electrode, and/or any combination thereof and/or any other method known for such purposes.

In embodiments, the apparatus further comprises a microcomputer, which can be used to monitor the characteristics detected by these sensors and then provide as needed feedback to the pump to adjust the electrolyte flow rate (and thus the residence time) and to the potentiostat (or other similar system) to adjust the electrical potential applied to the electrodes in order to maximize purified water throughput at a given output water quality.

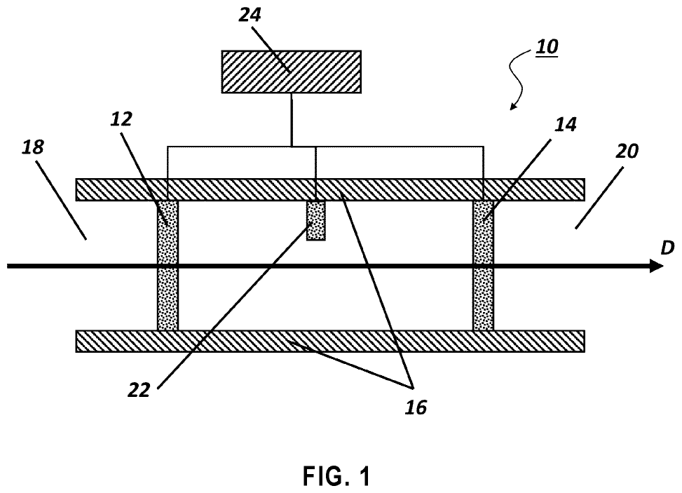

FIG. 1 is a cross-sectional schematic diagram of an electrochemical cell (10) for electrochemical water treatment according to an embodiment of the invention.

In this embodiment, the anode (12), cathode (14), and electrolyte are contained in a tubular vessel (16), which defines an electrochemical cell (10) with an inlet (18) and an outlet (20). This tubular vessel (16), can be made of any suitable material such as glass, plastic, or metal, preferably ceramic or plastic, more preferably ceramic. Examples of preferred plastic include perfluoroalkoxy alkane (PFA) tubing.

The anode (12) and cathode (14) are made of a porous conductive material and permeably occlude both ends of the tubular vessel (16) toward the inlet (18) and the outlet (20). The electrolyte thus flows through the electrochemical cell (including both electrodes, the inlet and the outlet) along a flow direction D. In alternative embodiments (not illustrated), the positions of the inlet and outlet are reversed, and the electrolyte flows through the electrochemical cell along the reverse direction.

A reference electrode (22) is provided within the tubular vessel (16) between the anode (12) and cathode (14).

A potentiostat (24) is used to supply an electric potential to supply to the anode (12) and cathode (14) and to group the reference electrode (22).

As needed, the apparatus and method of the invention can be scaled up either by using several electrochemical cells in parallel or by increasing the electrochemical cell volume (between the electrodes).

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### Description of Illustrative Embodiments

The present invention is illustrated in further details by the following non-limiting examples.

### EXAMPLE 1

### Removal of a Model Organic Contaminant

A saturated aqueous solution of a polychlorodibenzodioxin mixture (J&K Scientific, Edwardsville, Nova Scotia, Canada, product number ES-102) was prepared. Then, CuCl₂ and NaCl were added to this solution in concentrations of 100 82 M CuCl₂ and 500 mM NaCl.

An electrochemical reactor composed of two stainless steel pipes, each containing carbon felt, joined by a 30 cm length of perfluoroalkoxy alkane (PFA) tubing was connected to a reservoir of untreated water. Each carbon felt containing stainless steel pipe was used as an electrode and were connected to an external potentiostat. The applied voltage was 3 V.

The polychlorodibenzodioxin solution was allowed to pass gravimetrically through the electrochemical reactor.

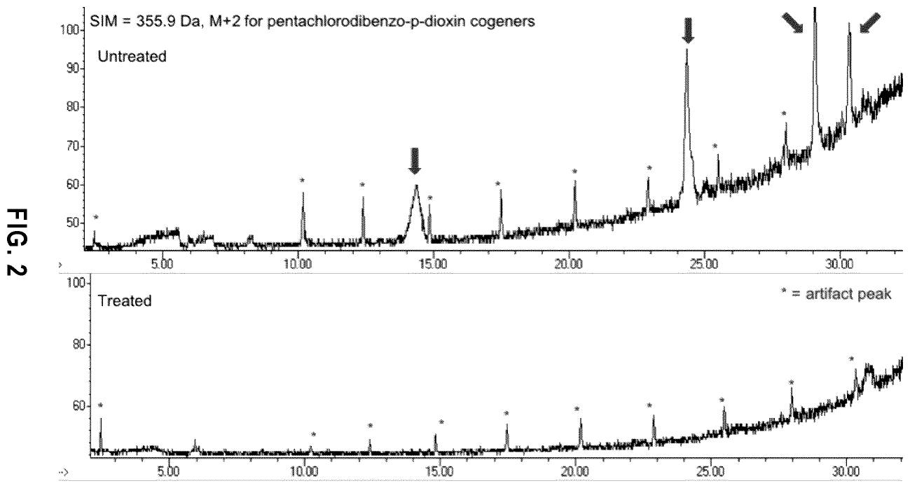

Both the starting solution and the resulting treated water were analyzed by observed via gas chromatography mass spectrometry (Agilent 6890N Network GC system with a 5973 inert mass selective detector using a J&K Scientific NSP-5 inert capillary column (30 m×0.25 mm×0.30 μm)) in selected ion monitoring mode. FIG. 2 shows the recorded MS spectra. The spectrum of the starting solution (top) clearly shows peaks for the polychlorodibenzodioxin mixture. These peaks are absent from the spectrum of treated water (bottom), showing the complete removal of the pentachlorodibenzodioxin cogeners.

### EXAMPLE 2

### Effect of Various Parameters on p-Nitroaniline Removal

All chemicals used in this study were of analytical reagent grade and used without further purification. Nanopure water (>18 M Ωcm) was obtained from a Barnstead Nanopure system. p-Nitroaniline was used as a model pollutant and sodium chloride as the electrolyte. Copper (II) chloride was used as the electrocatalyst. Solution pH was modified using HCl and NaOH where appropriate.

Reaction solutions comprising p-Nitroaniline (100 μM) were prepared using Nanopure water. Then, the desired amounts of CuCl₂ and NaCl were added to these solutions.

An electrochemical reactor comprising of stainless-steel electrode housings containing graphite felt electrodes connected by inert perfluoroalkoxy alkane (PFA) tubing (30 cm) was built. The reaction solutions were passed through the reactor using a peristaltic pump (0.6 mL/min for 1 h). The treated solutions were collected in a receiving flask and analyzed for residual total organic carbon (TOC) using an Analytik Jena multi N/C UV HS total organic carbon analyzer calibrated with known standards.

The TOC of the starting p-Nitroaniline reaction solutions (i.e. pre-treatment) was of 12.36 mg/L.

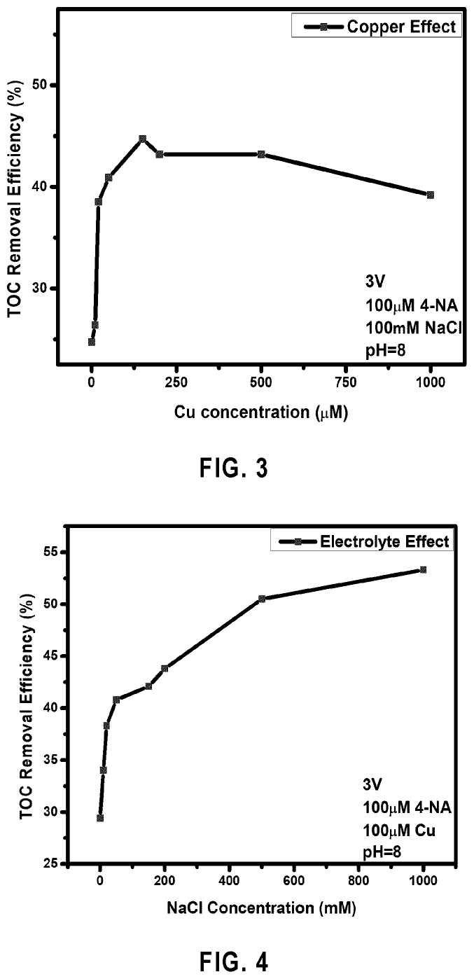

The Cu^{2±} concentration of the p-Nitroaniline reaction solution was varied from 0 to 1000 μM. The effects on TOC removal efficiency are shown in FIG. 3 and the table below.

| Cu (μM) | TOC (mg/L) |
|---|---|
| 0 | 9.31 |
| 10 | 9.1 |
| 20 | 7.6 |
| 50 | 7.3 |
| 100 | 8.25 |
| 150 | 6.84 |
| 200 | 7.02 |
| 500 | 7.02 |
| 1000 | 7.51 |

It can be seen that a Cu^{2±} concentration as low as 20 μM significantly increases p-nitroaniline removal (compared to using no Cu^{2±} at all).

The NaCl concentration of the p-Nitroaniline reaction solution was varied from 0 to 1000 mM. The effects on TOC removal efficiency are shown in FIG. 4 and the table below.

| NaCl (mM) | TOC (mg/L) |
|---|---|
| 0 | 8.73 |
| 10 | 8.16 |
| 20 | 7.62 |
| 50 | 7.32 |
| 100 | 8.25 |
| 150 | 7.16 |
| 200 | 6.95 |
| 500 | 6.12 |
| 1000 | 5.77 |

It can be seen that a NaCl concentration as low as 50 mM significantly increases p-nitroaniline removal (compared to using no NaCl at all).

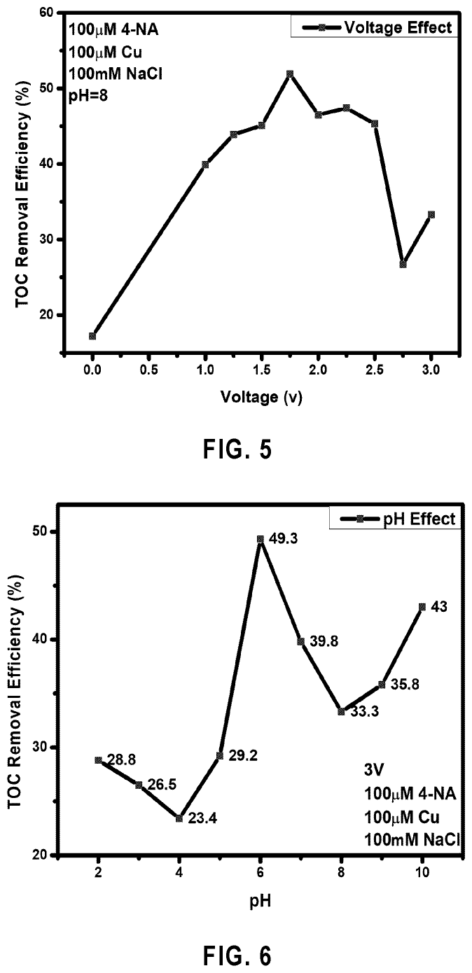

The voltage applied was varied from 0 to 3 V. The effects on TOC removal efficiency are shown in FIG. 5 and the table below.

| Voltage (V) | TOC (mg/L) |
|---|---|
| 0 | 10.24 |
| 1 | 7.43 |
| 1.25 | 6.97 |
| 1.50 | 6.93 |
| 1.75 | 5.95 |
| 2 | 6.61 |
| 2.25 | 6.5 |
| 2.5 | 6.76 |
| 2.75 | 9.06 |
| 3 | 8.25 |

It can be seen that an optimal potential, i.e., +1.75 V, favours pollutant mineralization over water oxidation.

The pH of the p-nitroaniline reaction solution was varied from 2 to 10. The effects on TOC removal efficiency are shown in FIG. 6 and the table below.

| pH | TOC (mg/L) |
|---|---|
| 2 | 8.8 |
| 3 | 9.08 |
| 4 | 9.47 |
| 5 | 8.75 |
| 6 | 6.27 |
| 7 | 7.44 |
| 8 | 6.5 |
| 9 | 7.93 |
| 10 | 7.04 |

It can be seen that TOC is reduced at all pH, with an increase in efficiency around pH 6.

Then, the effect of the residence time of the reaction solution in the electrochemical cell was studied. For this purpose, two reactor configurations were used. In one configuration, 10 cm of PFA tubing connected the electrodes together, which corresponded to a residence time of 1.5 minute. In the second configuration, the length of the PFA tubing was tripled (30 cm), which also tripled the residence time (4.5 minute). A 100 μM solution of p-nitroaniline with [CuCl₂]=100 μM and [NaCl]=500 mM was used as a reaction solution. The applied potential was 3 V. As a control, the reaction solution was passed through the 10 cm reactor, but no potential was applied to the electrodes to correct for adsorption of pollutants onto the graphite felt electrodes.

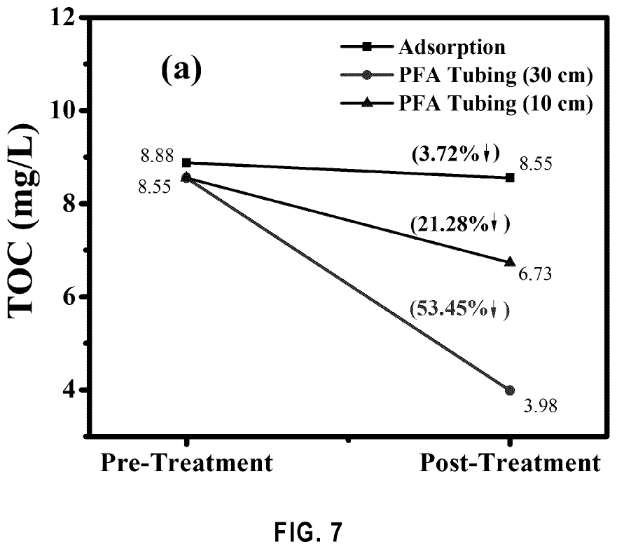

The results are shown in FIG. 7. The small TOC removal observed for the control (0 V) is possibly due to adsorption of the p-nitroaniline onto the graphite felt electrodes. It can be seen the increasing the residence time significantly increased TOC removal.

### EXAMPLE 3

### Treatment of Environmental Water at Lab and Field Scales

The method and device of the invention were used to treat environmental water, namely water from Boat Harbour, which is a body of water on the Northumberland Strait in Pictou County, Nova Scotia and which is known to be polluted with e.g. dioxins, furans, mercury and other toxic heavy metals. Three samples were collected: “Geotube”, “PW-1” and “PW-2”. These samples were obtained from Boat Harbour, Nova Scotia, Canada, an environmental remediation site. The “Geotube” sample was obtained from dewatering effluent leaving a geotube packed with coagulated sediment. The pore water samples, “PW-1” and “PW-2”, were obtained directly from unfiltered dewatering effluent from sediment samples obtained from two locations at the remediation site.

A field-scale electrochemical reactor was constructed similarly to that used in the lab scale as described in Examples 1 and 2. It consisted of an anode composed of a stainless steel pipe filled with carbon felt connected to pipe fittings used to divide the water flow into five different lengths of perfluoroalkoxy alkane tubing used in parallel to determine the effect of residence time for a real environmental water sample outside of the laboratory. The tubing lengths corresponded to residence times of 2, 4, 10, 20, and 40 min when the electrochemical reactor was operated at a flow rate of 50 mL/min per tube. At the end of each tube a short stainless-steel fitting filled with carbon felt was used as a cathode. The anode and cathodes were connected to an external potentiostat. Water samples were pumped into the anode and exited from the five cathodes. The water exiting from each cathode was collected for analysis.

The operating parameters were [CuCl₂]=100 μM, [NaCl]=100 mM, and V=3 V.

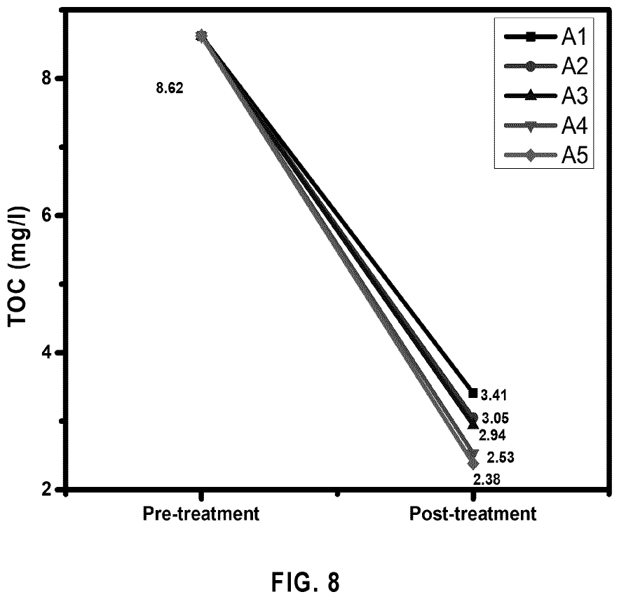

Efficiency of the water treatment was measured through reduction of total organic carbon (TOC), which was measured with an Analytik Jena multi N/C UV HS total organic carbon analyzer calibrated with known standards. TOC was measured for various residence times (i.e. time the water-being-treated resided in the electrochemical reactor). The TOC of the non-treated “geotube” sample (i.e. pre-treatment) was of 8.52 mg/L. The results of TOC removal during water-treatment for the “geotube” sample are shown in FIG. 8 and the table below.

| | Residence Time | Post-Treatment TOC | Efficiency |
|---|---|---|---|
| Sample | (min) | (mg/L) | (%) |
| A5 | 40 | 2.38 | 72.4 |
| A4 | 20 | 2.53 | 70.6 |
| A3 | 10 | 2.94 | 65.8 |
| A2 | 4 | 3.05 | 64.6 |
| A1 | 2 | 3.41 | 52.1 |

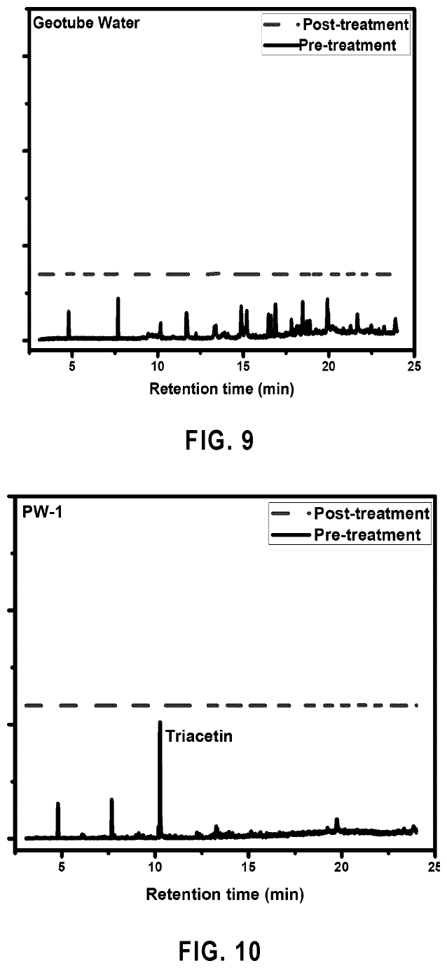

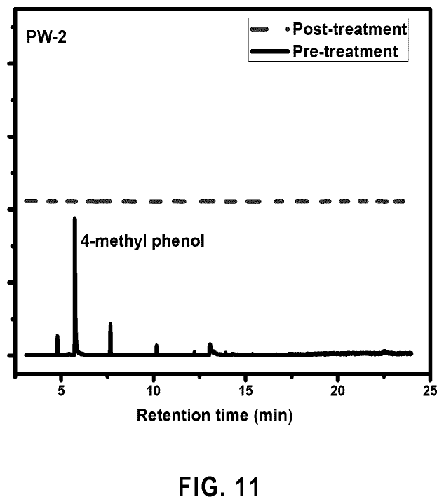

The volatile organic compounds in the “Geotube”, “PW-1”, and “PW-2” samples pre- and post-treatment were characterized by via GCMS (Agilent 6890N Network GC system with a 5973 inert mass selective detector using a J&K Scientific NSP-5 inert capillary column (30 m×0.25 mm×0.30 μm)). The results are shown in FIGS. 9 to 11. As can be seen in these figures, the volatile organic compounds have been largely removed from each sample.

Metal removal was characterized by inductively coupled plasma mass spectrometry (PerkinElmer Nexl ON 300D calibrated with a standard solution). The following table shows the results for the “Geotube” sample.

| | | | World Health |
|---|---|---|---|
| | [Mⁿ⁺] | [Mⁿ⁺] | Organization Maximum |
| | Pre-treatment | Post-treatment | Permissible Limit |
| Mⁿ⁺ | (mg/l) | (mg/l) | (mg/l) |
| Al | 7.56 | Non-detectable | 0.2 |
| Si | 42.2 | Non-detectable | |
| Ti | 8.93 | 1.97 | |
| Cr | 8.26 | 0.05 | 0.05 |
| Mn | 8.85 | 0.45 | 0.5 |
| Fe | 375 | Non-detectable | 1 |
| Co | 8.32 | Non-detectable | |
| Ni | 8.4 | Non-detectable | 0.2 |
| Zn | 45 | Non-detectable | 5 |
| As | 21.4 | Non-detectable | 0.05 |
| Sr | 7.83 | 0.23 | |
| Mo | 19.8 | Non-detectable | 0.07 |
| Cd | 7.44 | Non-detectable | 0.01 |
| Pb | 8.11 | 0.62 | 0.01 |

The following table shows the results for the “PW-1” sample.

| | | | World Health |
|---|---|---|---|
| | [Mⁿ⁺] | [Mⁿ⁺] | Organization Maximum |
| | Pre-treatment | Post-treatment | Permissible Limit |
| Mⁿ⁺ | (mg/l) | (mg/l) | (mg/l) |
| Al | 26.5 | Non-detectable | 0.2 |
| Ti | 0.658 | 0.066 | |
| Fe | 31.2 | 0.46 | 1 |
| Cd | 0.44 | 0.008 | 0.01 |
| As | 3.38 | Non-detectable | 0.05 |
| Zn | 47.4 | 0.2 | 5 |

The following table shows the results for the sample “PW-2” sample.

| | | | World Health |
|---|---|---|---|
| | [Mⁿ⁺] | [Mⁿ⁺] | Organization Maximum |
| | Pre-treatment | Post-treatment | Permissible Limit |
| Mⁿ⁺ | (mg/l) | (mg/l) | (mg/l) |
| Al | 30.7 | Non-detectable | 0.2 |
| Fe | 49.9 | Non-detectable | 1 |
| Zn | 27.3 | 0.033 | 5 |
| As | 0.9 | 0.06 | 0.05 |
| Cd | 0.44 | Non-detectable | 0.01 |

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
Ganiyu et al. Heterogeneous electro-Fenton and photoelectro-Fenton processes: A critical review of fundamental principles and application for water/wastewater treatment, Applied Catalysis, B: Environmental (2018), 235, 103-129.
Poza-Nogueiras et al. Current advances and trends in electro-Fenton process using heterogeneous catalysts—A review, Chemosphere (2018), 201, 399-416.
Umar et al. Trends in the use of Fenton, electro-Fenton and photo-Fenton for the treatment of landfill leachate, Waste Management (Oxford, United Kingdom) (200), 30(11), 2113-2121.
Brillas et al. Electro-Fenton Process and Related Electrochemical Technologies Based on Fenton's Reaction Chemistry, Chemical Reviews (Washington, DC, United States) (2009), 109(12), 6570-6631.
Valica et al. Effectiveness of Chlorella vulgaris inactivation during electrochemical water treatment, Desalination and Water Treatment (2019), 138, 190-199.
Chang et al. Photochemical Protection of Reactive Sites on Defective TiO2-x Surface for Electrochemical Water Treatment, Environmental Science & Technology (2019), 53(13), 7641-7652.
Jae-Chan et al. Superior anodic oxidation in tailored Sb-doped SnO2/RuO2 composite nanofibers for electrochemical water treatment, Journal of Catalysis (2019), 374, 118-126.
Le Luu, Green synthesis of RuO2 electrode for electrochemical water treatment, Journal of Environmental Science and Engineering B (2016), 5(7), 335-341.
lsarain-Chavez et al. Comparative study of electrochemical water treatment processes for a tannery wastewater effluent, Journal of Electroanalytical Chemistry (2014), 713, 62-69.
Chang et al. Electrochemical treatment of phenol-containing wastewater by facet-tailored TiO2: Efficiency, characteristics and mechanisms, Water research (2019), 165114980.
Heffron et al. Sequential electrocoagulation-electrooxidation for virus mitigation in drinking water, Water research (2019), 160435-444.
Chaplin, The Prospect of Electrochemical Technologies Advancing Worldwide Water Treatment, Accounts of chemical research (2019), 52(3), 596-604.
Radjenovic et al. Challenges and Opportunities for Electrochemical Processes as Next-Generation Technologies for the Treatment of Contaminated Water, Environmental science & technology (2015), 49(19), 11292-302.
Australian patent application, publication no. 2006/0203534
American patent application, publication no. 2011/0198238.
American patent application, publication no. 2015/0344333.
American patent no. 3,562,137.
International patent application, publication no. WO 2018/045355.
International patent application, publication no. WO 2015/176137.
International patent application, publication no. WO 2014/150792.

1. A method for electrochemical water treatment, the comprising the steps of:
a) supplying an aqueous solution comprising:
water to be treated,
chloride ions, and
copper(II) and/or copper(I) ions,
wherein the total copper ions concentration, [Cu²⁺]+[Cu⁺], in the aqueous solution is at least about 20 μM and the chloride ion concentration, [Cl⁻], in the aqueous solution is at least about 10 mM; and
b) electrochemically treating the aqueous solution in an electrochemical cell comprising an anode, a cathode, and the aqueous solution as an electrolyte, by applying an electric potential to said anode and said cathode, thereby producing purified water.

2. (canceled)

3. (canceled)

4. (canceled)

5. (canceled)

6. The method of claim 1, wherein the total copper ions concentration in the aqueous solution is at least about 50 μM.

7. The method of claim 1, wherein the aqueous solution supplied in step a) is produced by adding a water-soluble Cu(II) or Cu(I) salt to water to be treated.

8. (canceled)

9. The method of claim 1, wherein the total chloride ion concentration in the water solution is at least about 100 mM.

10. (canceled)

11. (canceled)

12. The method of claim 1, wherein the electric potential applied to the anode and the cathode ranges from about −1.5 to about +5 V.

13. The method of claim 1, wherein a different potential is applied to the anode and to the cathode.

14. The method of claim 13, wherein a potential between about +1.2 V and about +3.0 V is applied to the anode.

15. The method of claim 13, wherein a potential between about 0 V and about −1.5 V is applied to the cathode.

16. (canceled)

17. The method of claim 1, wherein the residence time of the aqueous solution in the electrochemical cell ranges from about 1 minute to about 1 hour.

18. (canceled)

19. (canceled)

20. (canceled)

21. (canceled)

22. An apparatus for electrochemical water treatment, the apparatus comprising
an electrochemical cell comprising an anode, a cathode, and an electrolyte, the electrolyte contacting the anode and the cathode;
an inlet allowing the electrolyte in the electrochemical cell; and
an outlet allowing purified water out of the electrochemical cell,
wherein the electrolyte is an aqueous solution comprising:
water to be treated,
chloride ions (Cl⁻), and
copper(II) and/or copper(I) ions,
wherein the total copper ions concentration, [Cu²⁺]+[Cu⁺], in the aqueous solution is at least about 20 μM and the chloride ion concentration, [Cl⁻], in the aqueous solution is at least about 10 mM.

23. (canceled)

24. The apparatus of claim 22, wherein the electrochemical cell is a flow-through electrochemical cell elongated in shape, and wherein the inlet is at one end of the electrochemical cell and the outlet at the other end of the electrochemical cell.

25. The apparatus of claim 22, wherein the anode and the cathode are made of a porous conductive material.

26. The apparatus of claim 22, wherein the anode and the cathode made of graphite felt or carbon felt.

27. The apparatus of claim 22, wherein the anode and the cathode each permeably occlude one end of the electrochemical cell towards the inlet and the outlet.

28. The apparatus of claim 22, further comprising a reference electrode.

29. The apparatus of claim 22, further comprising a pump for mobilizing the electrolyte through the electrochemical cell.

30. (canceled)

31. The apparatus of claim 22, further comprising one or more sensors for detecting one or more characteristics of the electrolyte entering the electrochemical cell and/or one or more characteristics of the purified water exiting the electrochemical cell.

32. The apparatus of claim 29, further comprising a microcomputer.

33. The apparatus of claim 32, wherein the microcomputer monitors the one or more characteristics detected by the one or more sensors and/or provides feedback as needed to the pump to adjust the electrolyte flow rate and/or to the a voltage source to adjust the electrical potential applied to the electrodes to maximize purified water throughput at a given output water quality.

34. The apparatus of claim 22, comprising several electrochemical cells in parallel.

35.-38 (canceled)
